(19) United States
(12) Patent Application Publication
(10) Pub. No.: US 2011/0024578 A1
(43) Pub. Date: Feb. 3, 2011

(54) INTRAVENOUS OR ELECTRICAL LINE ORGANIZER DISPENSER

(76) Inventors: Bruce D. Spiess, Manakin-Sabot, VA (US); Rachel M. Jones, Houston, TX (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/742,315

(22) PCT Filed: Nov. 5, 2008
(86) PCT No.: PCT/US08/82422

§ 371 Date: Sep. 24, 2010

Related U.S. Application Data
(60) Provisional application No. 60/987,336, filed on Nov. 12, 2007.

(51) Int. Cl. F16L 3/22; B65D 85/67

(52) U.S. Cl. 248/68.1; 242/588.3

(57) ABSTRACT

An intravenous or electrical line organizer dispenser is provided. The dispenser comprises a flexible backing support separable into a plurality of sections. Each section, constitutes a line organizer by itself, includes several spaced apart longitudinally channel connectors which are designed to snap-fit intravenous lines or electrical cables thus keeping the lines separated and organized. Each individual section is also provided with a means to secure the two opposite sides of the flexible backing support which can be rolled longitudinally inwards for protection and organization of the lines or cables during patient transport. The backing support is also able to be rolled outwards for display and organization of the lines on an intravenous pole. The line organizer dispenser is made of a continuous flexible sheet roll of a plurality of line organizer sections with a perforation line between sections so that the user can select and tear off the length required.

### PRIORITY INFORMATION

This application claims priority to U.S. Provisional application Ser. No. 60/987,336, filed Nov. 12, 2007.

### BACKGROUND OF THE INVENTION

1. Field of the invention

This invention generally relates to line organizer devices which hold, separate and organize intravenous lines or electrical cables associated with monitoring equipment. In one application, the organizer will be used in conjunction with a patient, and provides for intravenous line and cable organization during stationary treatment or during transport of a patient.

2. Background description

When treating a patient, simultaneous administration of several intravenous solutions and/or drugs as well as measurements of, for example, central venous pressure or pulmonary artery pressure is very often required. This leads to the use of numerous intravenous lines and electric cables from monitoring equipment to a patient in various medical environments, including operating rooms, intensive care units and emergency rooms.

Intravenous lines extend either from an intravenous pole to an injection site on the patient, or from a catheter attached to the patient to monitoring equipment. One task of medical personnel is to inspect and ensure that each intravenous line is properly identified and connected. It is common that the intravenous lines are quite long to allow for ease of movement for the patient who is placed on medication and/or monitoring equipment. Anesthesia providers spend significant amounts of unproductive time per day to detangle and sort intravenous and electrical lines. Also, when a patient is transferred from the operating room table to the intensive care unit, the post-operative period is critical for the outcome and survival of the patient. Time is wasted by medical personnel detangling and tending lines carefully so that they are not caught on anything, whereas such time could be better spent attending to the patient or other crucial matters. Further, in the case where the number and/or length of the intravenous lines increases, the task becomes even more difficult and time consuming, especially when both the lines and the fluid running through them are clear, thus making it more difficult to differentiate one line from another. More importantly, the likelihood of line entanglement and accidental line removal increases, which can lead to serious consequences such as the loss of intravenous/intra-arterial access, the discontinuation of the infusion of a drug or fluid or an exsanguination at the site line. The Institute of Medicine states that up to 98,000 Americans die per year form medical human errors, a portion of which may be due to intravenous line entanglements. Traditionally, intravenous lines are sometimes taped to the skin of the patient to keep the lines both separated and organized. However, when it is required for a patient to be transported or repositioned, the tape could be difficult to remove from the skin and inevitably the lines again become tangled. It is more problematic in the case of trauma patients in intensive care unit because they frequently have numerous open wounds on them. Thus, applying tape to the skin of these patients may not be an option.

In order to reduce these inconveniences, different devices have been developed in the prior art. Examples of such devices are described in US Pat. App. Pub. Nos. 2004/0099426 to Bryl, 2005/0103949 to Ross, 2001/049504 to Gautsche, and U.S. Pat. Nos. 5,460,493 to Deniega and 5,870,805 to Kandler.

Although the devices disclosed in the prior art are designed to be used as line organizers, they are often complicated and do not offer valuable features such as a view-through of the lines, an easy attachment/detachment of the lines, the flexibility and versatility of utilization, a practical dispenser of the line organizers, the durability of the device and a low cost to manufacture, all of which constitutes an asset for this type of device.

Therefore, there is a need in hospitals and other medical care facilities during normal use and patient transport for a line organizer that improves patient safety, easy to use and inexpensive to produce. Further, an improved line organizer might be advantageous in non-medical applications including computer and electronic applications.

### SUMMARY OF THE INVENTION

It is an object of the present invention to provide an improved line organizer and dispenser which overcomes the problems of the prior art and which is designed, in one embodiment, to efficiently assist medical personnel and anesthesia providers.

According to the invention, the line organizer dispenser is composed a line organizer, each of which includes a flexible backing support that provides a plurality of individual sections, each section constituting by itself an intravenous/electrical line organizer. The line organizer comprises two or more longitudinally spaced-apart channel connectors which are able to snap-fit intravenous lines or electric cables so that the lines and/or cables are separated and held securely and parallel to each other. Further, the line organizer may be narrower or wider so that it can accommodate fewer or more channel connectors/lines. The snap-fit system is able to hold a variety of catheter diameters including the usual ⅛ inch diameter intravenous lines. Furthermore, because the flexible backing support holds the lines on a significant length (e.g. 4-6 inches or more), it efficiently prevents the lines from tangling.

According to another aspect of the invention, the flexibility of the backing support allows it to be rolled longitudinally either inwards or outwards, providing numerous uses and advantages. The line organizer includes a means for securing together the two opposite sides of the flexible backing support. This can take the form of snaps, Velcro®, or a strap and couple configuration. The strap configuration is preferred as it can be molded or extruded simultaneously with the rest of the dispenser. Rolled in the inward configuration, the device provides both protection and organization of the lines during transport of the patient. Rolled in the outward configuration, the device is able to provide display and organization of the lines on an intravenous pole, hospital bed, or other medical apparatus when in stationary use.

The securing means preferably comprises a first member, extending from one side of the flexible backing support, which is made of one or more straps including a series of openings. On the directly opposite side of the flexible backing support is preferably positioned a second member, also made of one or more straps, which can be joined to the first joining member. The connection may be performed by a male-female type connection and the two members may be made from the same plastic material as the flexible backing support. The two joining members may have a variety of designs such as a Velcro® fastener strap with a loop on one side of the flexible backing support and a joining member which can pass through the loop on the other side and can be secured back on itself.

It is yet another aspect of this invention to provide the device optionally with one or more pieces of a peel-and-stick adhesive which is preferably positioned on the back side of the flexible backing support. If desired, the medical personnel can stick the adhesive of the line organizer to a bed rail or any other support available close to the patient so that the lines are displayed and kept organized. The adhesive used for this purpose can be of any type of modern adhesives. When no longer needed, the device can be peeled away and the line organizer device disposed of.

It is yet another aspect of this invention to provide a line organizer dispenser in the form of a flexible rolling sheet with perforation lines running between adjacent sections, where each section includes at least one line organizer. Such a design has the advantage that it allows the user to select and tear off the length of line organizer desired according to each medical situation. This configuration might also benefit complex computer and electrical applications where multiple lines need to be organized.

### BRIEF DESCRIPTION OF THE DRAWINGS

The foregoing and other objects, aspects and advantages of the present invention will be better understood from the following detailed description of the preferred embodiments with reference to the drawings, in which:

FIG. 1A is a top plan view of an intravenous or electrical line organizer according to the invention showing a flexible backing support to which an intravenous line is attached.

FIG. 1B is a bottom plan view of an intravenous or electrical line organizer according to the invention showing a flexible backing support to which an intravenous line is attached.

FIG. 2 is a section view in perspective of the flexible backing support rolled longitudinally in a configuration so that the intravenous lines or electrical cables pass through longitudinally and are located on the internal surface of the flexible backing support.

FIG. 3 is a section view in perspective of the flexible backing support rolled longitudinally in a configuration so that the intravenous lines or electrical cables pass through longitudinally and are located on the external surface of the flexible backing support.

FIG. 4 is a partial isometric view of the intravenous or electrical line organizer dispenser according to the invention.

### DETAILED DESCRIPTION

In one embodiment, the line organizer is specifically designed to assist medical personnel and anesthesia providers in operating rooms, intensive care units, emergency rooms, and other medical environments dealing with the care of patients. It will be understood that the device provides rapid, flexible and simple maintenance to keep a number of lines in order, including, but not limited to, intravenous lines and electrical cables from monitoring apparatuses.

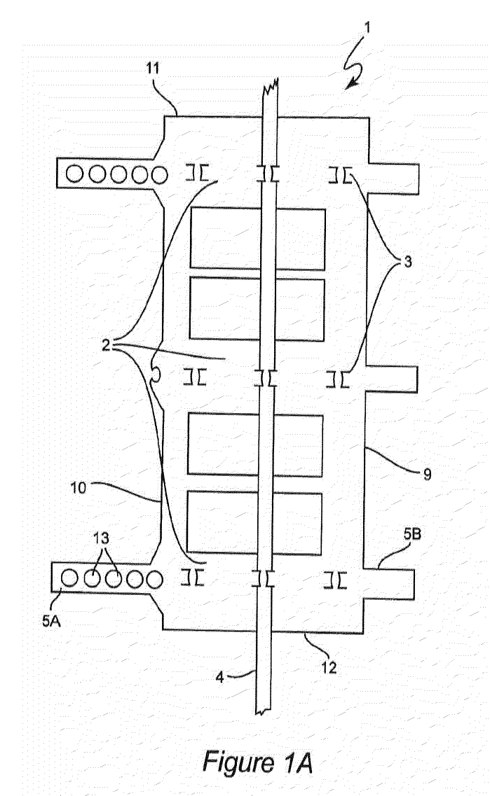

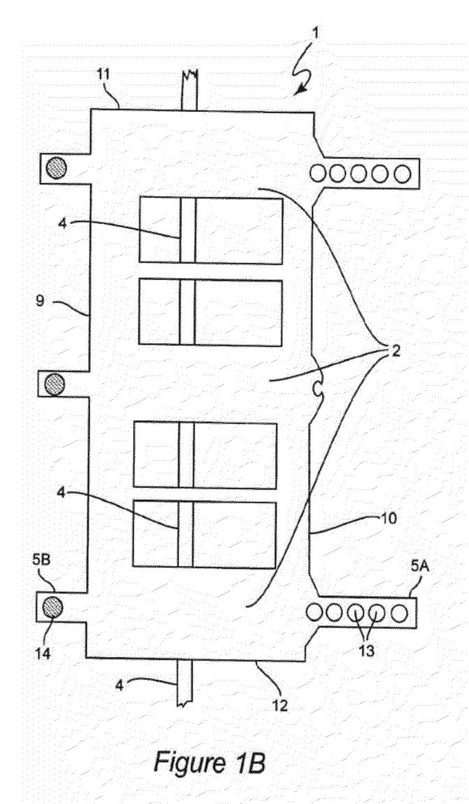

FIGS. 1A and 1B show the preferred embodiment of the line organizer of the present invention. A flexible backing support 1 contains a plurality of sections 2. The flexible backing support may be made from a pliable plastic material; however, other materials such as cardboard or rubber might also be used. The support 1 should be thick enough to be durable while still allowing it to be rolled longitudinally. Each section preferably comprises at least two groups of channel connectors 3 located on the upper surface of the backing support 1. The channel connectors 3 are configured to snap-fit connect intravenous lines 4. Enlargement 6 in FIG. 2 shows an example of a snap-fit connection which permits one line 4 to be easily attached to and detached from the backing support 1. It would be understood that the number of channel connectors/lines is not limited to three as shown in FIGS. 1A, 2 and 3, but that this number can vary, for example, from two to ten. The channel connectors 3 are preferably made from pliable plastics and most preferably from the same plastic or other material as the backing support 1 so that the entire product can be extruded or molded simultaneously. The connectors 3 allow a line 4 to be snapped down or pulled up, detachably securing an intravenous line 4 having a variety of sizes such as the usual ⅛^{th} inch diameter intravenous lines. Although the Figures show the use of channel connectors configured to snap-fit an intravenous line into place, other types of simple connecting configurations (e.g., Velcro straps, cutouts to thread the lines through, etc.) may be used within the scope of the present invention. The flexible backing support 1 enables the line organizer to be rolled longitudinally inward for protection and organization of the lines secured by the channel connectors 3 during transport of the patient. The flexible backing support 1 also has the ability to be rolled outwards for display and organization of intravenous lines 4 on an intravenous pole while in stationary use.

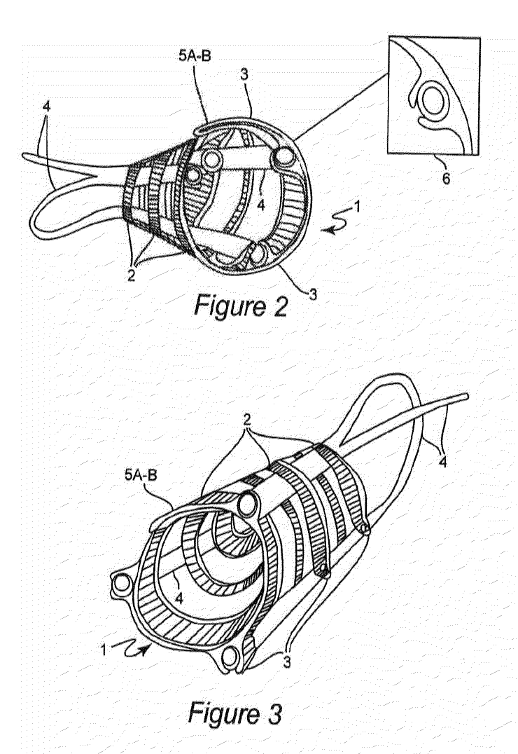

FIGS. 1A and 1B also shows that the line organizer includes a means for securing together the first and second sides, 9 and 10, of the flexible backing support 1 when longitudinally rolled together. In the embodiment shown in FIGS. 1A and 1B, a strap member 5A with a number of openings 13 extending from one side of the flexible backing support that can be joined to another member 5B with a pushbutton 14 extending from the other side of the flexible backing support. When the flexible backing support 1 is longitudinally rolled such that the first 9 and second 10 sides come together, the pushbutton 14 is pushed through at least one of the openings 13 to secure the flexible backing support 1 in the rolled forms as shown in FIGS. 2 and 3. While not shown, the members 5A and 5B for securing the two opposite sides of the flexible backing support 1 may have different designs such as a hook element of a loop and a loop fastener, Velcro®, or other simple joining systems.

Referring to FIG. 2, the strap connector 5A-B for securing the two sides of the flexible backing support 1 allows the channel connectors 3 which snap-fit the lines 4 inside the longitudinal roll formed by the flexible backing support 1. When the device is used in this configuration, the lines 4 are protected and can be transferred in a compact unit for easy travel and preventing the lines from tangling.

As shown in FIG. 3, the strap connector 5A-B for securing the two sides of the flexible backing support 1 allows the channel connectors 3 which snap-fit the lines 4 outside the longitudinal roll formed by the backing support 1. When the device is used in this configuration, the lines 4 can be displayed and placed anywhere in an organized manner to permit convenient and safe administration of fluid(s) and drug(s).

Alternatively, if the line organizer will not be used during transport, the present invention contemplates the use of a sticker-type version of the line organizer that would not include the strap connector 5A-B, or the like. The line organizer can include a peel-off backing on one side of the flexible backing support 1 such that a user would simply retrieve one or more line organizers from the dispenser, peel off the backing, and stick the line organizer to any acceptable place that the medical personnel desires. This embodiment of the present invention would be useful in medical environments where medicine delivery to a patient via intravenous line is needed only during a specific medical procedure (e.g., surgery).

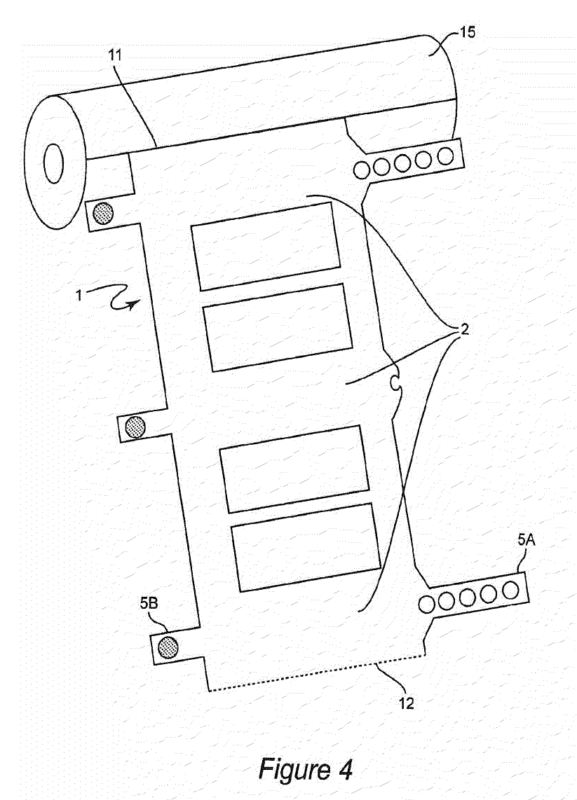

Referring now to FIG. 4, in a preferred embodiment the top and bottom, 11 and 12, of the line organizer have perforations or score markings, and the flexible backing support 1 is a continuous extrusion. This allows multiple line organizers to be stored in a dispenser 15. The dispenser 15 can be any type of paper dispenser, or the like. For example, the dispenser 15 can be an electronic push-button or motion sensor dispenser, or a manual pull-lever or standard paper roll dispenser. The medical personnel or other people in need of a line organizer would simply have to tear off, cut or otherwise retrieve one or more line organizers from a dispenser 15.

While the invention has been described in terms of its preferred embodiments, those skilled in the art will recognize that the invention can be practiced with modification within the spirit and scope of the appended claims.

1. An intravenous or electrical line organizer dispenser, comprising:
a flexible backing support having a front side and a back side which is separable into a plurality of sections, each section defining a single line organizer comprised of
i) at least two longitudinally spaced apart groups of channel connectors positioned on said front side of said flexible backing support wherein first channel connectors in a first of said two spaced apart groups are paired with second channel connectors in a second of said two spaced apart groups, and wherein individual channel connectors in said two longitudinally spaced apart groups of channel connectors are configured to snap-fit connect intravenous lines, electrical cables, or other conduits; and
ii) a means for securing first and second sides of said flexible backing support together in a configuration where said flexible backing support is rolled longitudinally, wherein said intravenous lines, electrical cables, or other conduits may pass through said backing support or be secured adjacent to said backing support in said configuration; and
means for separating said flexible backing support into individual sections of said plurality of sections.

2. The intravenous or electrical line organizer dispenser of claim 1, wherein each section of said flexible backing support includes one or more openings between said at least two longitudinally spaced apart groups of channel connectors which allows said intravenous lines, electrical cables, or other conduits that are snap-fit connected to said channel connectors to be viewed when said flexible backing support is secured in said configuration where said flexible backing support is rolled longitudinally.

3. The intravenous or electrical line organizer dispenser of claim 1, wherein said means for securing secures said first and second sides together with said channel connectors inside said configuration where said flexible backing support is rolled longitudinally.

4. The intravenous or electrical line organizer dispenser of claim 1, wherein said means for securing secures said first and second sides together with said channel connectors outside said configuration where said flexible backing support is rolled longitudinally.

5. The intravenous or electrical line organizer dispenser of claim 1, wherein said means for securing includes at least one strap extending from a first side of said flexible backing support which includes a plurality of openings which can be joined to a joining member on a second side of said flexible backing support.

6. The intravenous or electrical line organizer dispenser of claim 1, wherein said means for separating is a perforation line running between individual sections of said plurality of sections.

7. An intravenous or electrical line organizer, comprising:
a flexible backing support having a front side and a back side;
at least two longitudinally spaced apart groups of channel connectors positioned on said front side of said flexible backing support wherein first channel connectors in a first of said two spaced apart groups are paired with second channel connectors in a second of said two spaced apart groups, and wherein individual channel connectors in said two longitudinally spaced apart groups of channel connectors are configured to snap-fit connect intravenous lines, electrical cables, or other conduits; and
a means for securing first and second sides of said flexible backing support together in a configuration where said flexible backing support is rolled longitudinally, wherein intravenous lines, electrical cables, or other conduits may pass through said backing support or be secured adjacent said backing support in said configuration.

8. The intravenous or electrical line organizer of claim 7, wherein said flexible backing support includes one or more openings between said at least two longitudinally spaced apart groups of channel connectors which allows intravenous lines, electrical cables, or other conduits that are snap-fit connected to said channel connectors to be viewed when said flexible backing support is secured in said configuration where said flexible backing support is rolled longitudinally.

9. The intravenous or electrical line organizer of claim 7, wherein said means for securing secures said first and second sides together with said channel connectors inside said configuration where said flexible backing support is rolled longitudinally.

10. The intravenous or electrical line organizer of claim 7, wherein said means for securing secures said first and second sides together with said channel connectors outside said configuration where said flexible backing support is rolled longitudinally.

11. The intravenous or electrical line organizer of claim 7, wherein said means for securing includes at least one strap extending from a first side of said flexible backing support which includes a plurality of openings which can be joined to a joining member on a second side of said flexible backing support.
